(19) United States
(12) Patent Application Publication
(10) Pub. No.: US 2025/0196013 A1
(43) Pub. Date: Jun. 19, 2025

(54) SYSTEMS AND METHODS FOR ELECTRONIC GAME CONTROL FOR CURRENCY REWARDS AND TARGET GOAL CONTROL

(71) Applicant: Sony Interactive Entertainment Inc., Tokyo (JP)

(72) Inventors: Glenn Black, San Francisco, CA (US); Sharath Rao, San Francisco, CA (US); Murugan Rajenthiran, Bangalore Urban (IN)

(73) Assignee: Sony Interactive Entertainment Inc., Tokyo (JP)

(21) Appl. No.: 18/540,828

(22) Filed: Dec. 14, 2023

(51) Int. Cl. A63F 13/79; A63F 13/49; A63F 13/533; G06F 3/01

(52) U.S. Cl. CPC A63F 13/79; A63F 13/49; A63F 13/533; G06F 3/013

(57) ABSTRACT

System, process, and device configurations are provided for electronic game control for game rewards and target goal control. A method can include receiving a target goal for at least one user and controlling electronic game content presentation on a display. The method can also include detecting user actions relative to the electronic game content presentation, including monitoring presentation time of the electronic game content and evaluating the user actions relative to the target goal. The method can also include updating the electronic game content based on the target goal and game presentation time, and generating a reward for target goal completion. Systems and processes described herein may be used for behavior modification, such as limiting playtime of electronic content. Systems and processes described herein may also be used to providing a training function for electronic games that includes user set goals for self-improvement.

### FIELD

The present disclosure is directed to systems and methods for game rewards and target control in electronic games and interactive entertainment control, including electronic game control, game content generation, gaming device operations, and gaming device processes.

### BACKGROUND

Computer and console game titles have been developed in many styles for different gaming systems and platforms. While electronic gaming is extremely popular and has a large user base, there is a desire to promote player wellbeing. Users have a varying spectrum of needs and gameplay styles. There is a desire and a need to provide controls in a personalized manner for users. Some games include timers that require a user to complete a level or perform a function within a time period. These timers and time periods do not limit the amount of time a user to can continue to use a device. In addition, these timers narrowly control portions of games and do not track user use of a device. There is a desire to provide functionality for device moderation as conventional in-game timers may be overcome. There is also a need and a desire for promoting user performance and providing tools to assist players. While many game may track accumulation of points or data, these functions typically do not allow for a user to track specific goals. With competitive gaming, there is a desire for user s to track personalized goals for one or more game titles. As such, there is also a desire for configurations and processes that allow for control of electronic game control to promote player wellbeing.

### BRIEF SUMMARY OF THE EMBODIMENTS

Disclosed and described herein are systems, methods and device configurations for electronic game control for game rewards and target goal control. In one embodiment, a method includes receiving, by a device, a target goal for at least one user, and controlling, by a device, electronic game content presentation on a display. The method also includes detecting, by the device, user actions relative to the electronic game content presentation, wherein detecting includes monitoring presentation time of the electronic game content and evaluating the user actions relative to the target goal. The method also includes updating, by the device, the electronic game content presentation based on the target goal and the presentation time of the electronic game content, wherein updating includes generating a reward for target goal completion.

In one embodiment, the target goal includes at least one in-game performance goal.

In one embodiment, the target goal includes a time limit for presentation of the electronic game content.

In one embodiment, controlling electronic game content presentation is based on a fixed time resource for the user, the fixed time resource allocating a time amount for gameplay per day.

In one embodiment, detecting user actions relative to electronic game content presentation includes eye tracking detection of a user.

In one embodiment, detecting user actions relative to electronic game content presentation includes measuring use of a time allowance for gameplay based on eye tracking detection of a user, and wherein a game reward includes a time duration parameter for eye track and a currency value for in-game use.

In one embodiment, detecting user actions relative to electronic game content

presentation includes detecting a user playtime within a time allowance and wherein updating includes generating a reward for the user.

In one embodiment, updating the electronic game content presentation includes generating a game system currency reward.

In one embodiment, updating the electronic game content presentation includes terminating presentation of the electronic game content based on user playtime exceeding a time allowance.

In one embodiment, the method includes receiving a user goal self input, the user goal self input identifying at least one of a target goal and time allowance for electronic game content presentation.

Another embodiment is directed to a device configured for electronic game control for game rewards and target goal control. The device includes an interface configured to output gaming content, a memory storing executable instructions and a controller, coupled to the interface and memory. The controller is configured to receive a target goal for at least one user, and control electronic game content presentation on a display. The controller is configured to detect user actions relative to the electronic game content presentation, wherein detecting includes monitoring presentation time of the electronic game content and evaluating the user actions relative to the target goal. The controller is configured to update the electronic game content presentation based on the target goal and the presentation time of the electronic game content, wherein updating includes generating a reward for target goal completion.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is a graphical representation of electronic game control for game rewards and target goal control according to one or more embodiments;

FIG. 2 illustrates a process for electronic game control for game rewards and target goal control according to one or more embodiments;

FIG. 3 illustrates a graphical representation of a device configuration according to one or more embodiments;

FIG. 4 illustrates a process for setting at least one target goal according to one or more embodiments; and

FIG. 5 is a graphical representation of updating electronic game content presentation according to one or more embodiments.

### DETAILED DESCRIPTION OF THE EXEMPLARY EMBODIMENTS

### Overview and Terminology

System, process, and device configurations are provided for electronic game control for game rewards and target goal control. Embodiments include device configurations and processes to control the presentation of electronic game content based on one or more of a target goal and duration of play. These embodiments aim to promote player wellbeing through customization of one or more game operations for a user and by providing functionality that allows for user goal setting, game time moderation, and player incentives. According to embodiments, a system level solution is provided for monitoring use of a gaming device, such as a game console, and duration of electronic gaming content presentation. In addition to monitoring use, system configurations and processes provide operations to allow a user to set goals for self-improvement. User goals may improve player wellbeing and moderate excessive gameplay by providing a time duration or limit for gameplay. Players may be provided a time limit, such as daily allowance, and may set one or more individual goals for self-improvement. The goals can range from in-game performance goals for professional gamers (e.g., win X number of rounds each day), to lifestyle goals for addiction prone players (e.g., time limit of 1 hour a day). Incentives may be generated for players adhering to user goals, including but not limited to generating or outputting a system-wide-currency or generating rewards for achieving goals.

A method for electronic game control for game rewards and target goal control can include receiving at least one target goal for a user and controlling electronic game content presentation on a display. The target goal may be used to include one or more limits and goals with respect to a user and at least one or more game titles. For illustration, the target goal is discussed with reference to a game title, however, it should be appreciated that target goals may be applied to one or more game titles and functions of an interactive gaming device.

Configurations and processes may be used to receive target goals, set device operation relative to received target goals and monitor user actions towards one or more target goals. Configurations and processes may be used to generate rewards based on meeting a target goal. Rewards may be in-game rewards and/or system wide currency for one or more game titles. Rewards can function as a system-wide currency to add features to one or more game titles and spent on system level items/games/traded.

System and device configurations are provided including operations performed by an interactive control device, such as a game console, display device, and handheld gaming device. Configurations may also be employed by network device or server to control media output or provide control signals to an interactive control device. Systems and methods also provide configurations and operations for controlling the output of electronic game content to improve device performance. Processor and device functionality may be improved by using processes and configurations to detect user actions relative to electronic game content presentation.

One aspect of the disclosure is directed to promoting player wellbeing. Duration of gameplay, including a time period that a user is engaged with a game title, may be controlled. According to embodiments, players may be provided with a daily allowance of gameplay across one or more game titles. To detect gameplay, processes and devices may use eye tracking data as an input for monitoring. By using eye tracking data, gameplay duration may be accurately tracked. Gameplay duration can be estimated using one or more of camera data and eye tracking data.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

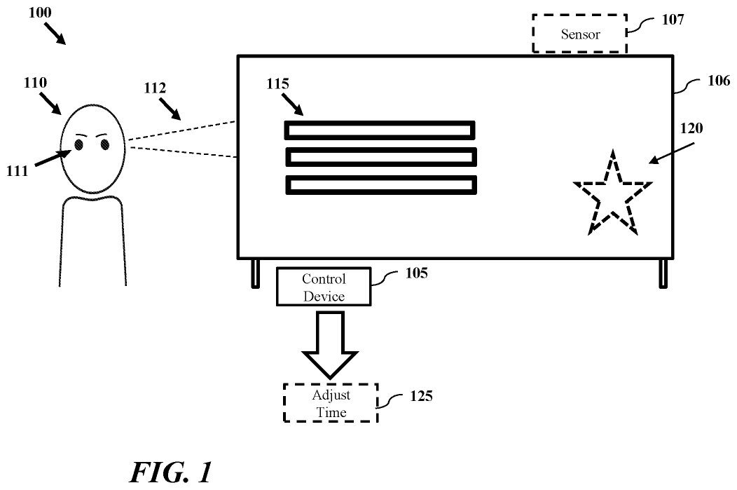

FIG. 1 is a graphical representation of electronic game control according to one or more embodiments. System 100 may be configured for presenting electronic game content on a display and detecting a user action relative to presented electronic game content. According to embodiments, one or more devices of system 100 may be configured for electronic game control for game rewards and target goal control. System 100 includes control device 105 which may be configured to control electronic game content presentation on display 106. According to embodiments, control device 105 may be a standalone device, such as a game console or game media player. According to embodiments, control device 105 and display 106 may be parts of the same unit, such as a display device with a processor or a handheld gaming device.

According to embodiments, control device 105 may be configured to detect user actions relative to the electronic game content presentation for user 110, and relative to the electronic game content. FIG. 1 illustrates game content presentation 115. Detecting user actions can include monitoring presentation time of the electronic game content and evaluating user actions relative to a target goal. Control device 105 may be configured to control presentation format for the electronic game content based on one or more of target goal and presentation time.

According to embodiments, the electronic game content presentation may be updated based on the target goal and the presentation time of the electronic game content. Updating can include generating a reward for target goal completion, and control device 105 may be configured to output reward 120 to a user.

According to embodiments, control device 105 may be configured to control presentation format for electronic game content based on one or more of a target goal and actions of a user, such as user 110. User actions, including control inputs, game progress, game results and user activity in general may be detected by control device 105. Detecting user actions can include monitoring presentation time of the electronic game content and evaluating the user actions relative to the target goal. In addition to detecting user actions, configurations and processes of control device 105 may be used to generate game rewards based on target goal completion. Processes may be used to promote player wellbeing, provide incentives for completing goals, moderate gameplay duration, provide feedback and improve device operation.

According to embodiments, user actions may be detected and monitored, with user permission, during output of an electronic game and interactive media in general. According to embodiments, control device 105 relates to a media output device, such as a game console. It should be appreciated that that one or more of a server and display device 106 may be configured to provide electronic game functions, game control and interactive media output. It should also be appreciated that detection of a user actions is not limited to electronic games. The principles of the disclosure may be provided to other forms of network and interactive communication, and device control in general. For purposes of illustration and example of operation, system 100 and control device 105 may detect a user actions for user 110 during presentation of electronic game content 115 by display 106. User 110 can provide input controls for an electronic game output received by control device 105. According to embodiments, one or more elements of system 100 may be used to detect user actions. According to embodiments, system 100 may include sensor 107 to detect one or more of user actions and duration of gameplay. Sensor 107 may be an image capture device, such as a camera configured to capture images and/or video image date of user 110. According to embodiments, sensor 107 may provide image data to control device 105. Control device 105 may be configured to capture position and features of eyes 111 of user 110 to perform eye tracking. Using image data and eye tracking data, control device 105 may be configured to detect and track one or more of user gaze 112, a focus point, and a display area a user is viewing.

According to embodiments, control device 105 may receive output from one or more devices, such as sensor 107 or display 106 when sensor 107 is included as part of display 106. According to embodiments, detection of user actions may be performed using a machine learning model. According to embodiments, system 100 may be configured to use and update machine learning models. Based on at least one of a target goal and duration of gameplay, control device 105 may be configured to update a presentation format and the electronic game content using the presentation format. According to embodiments, the presentation format modifies the electronic game content presentation to include one or more of audio and video outputs for indicating reward 120. According to other embodiments, control device 125 may adjust time at optional block 125 when a target goal is a limitation on the amount of time content may be presented for some interval such as one day or more than one day. Users may be allotted a predetermined period of time, self-select time or receive time limitations.

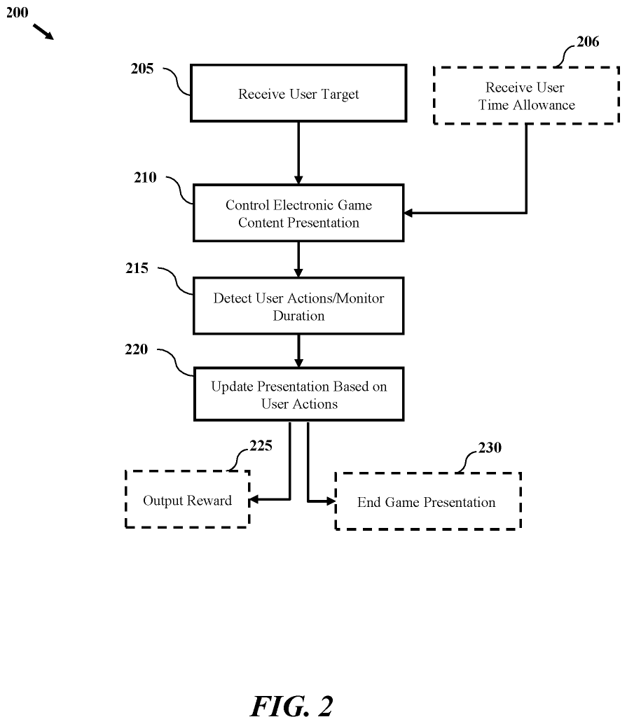

According to embodiments, control device 105 may be configured to perform one or more network operations including communicating with one or more servers on a communication network. Control of electronic game content presentation may be based on one or more communications from a network server, including game servers. Control device 105 and one or more components of system 100 may be configured to perform processes described herein, including process 200 of FIG. 2, and process 400 of FIG. 4.

System 100 may provide features to improve user experience, wherein functions and operations described herein are performed following user consent, with express notice to a user, and/or in alignment with one or more user settings for user privacy. It should be appreciated that embodiments may be applied to interactive entertainment with one or more users. Processes described herein are not limited to gaming content.

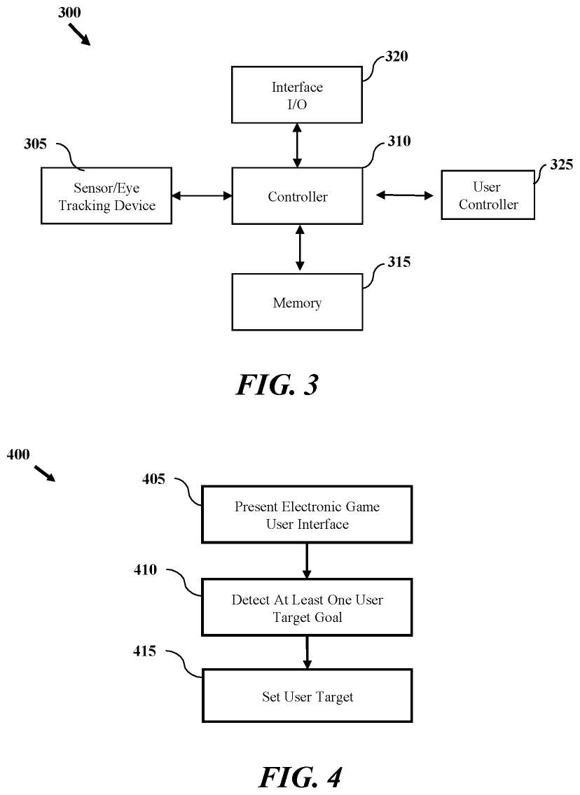

FIG. 2 illustrates a process for electronic game control for game rewards and target goal control according to one or more embodiments. Process 200 may be performed for interactive game control and can include controlling presentation format for the electronic game content based on one or more of detected user actions, a target goal for a user and presentation time of electronic game content. Process 200 may be configured to generate one or more rewards of a user based on accomplishing a user target goal. Process 200 may be configured to control presentation of content, such as gaming content, gaming video and audio output, such that the duration of playtime does not exceed one or more time limitations of a user. Process 200 may be performed by a device, such as device 300 and/or controller 310 of FIG. 3. Process 200 may be initiated by a device (e.g., control device 105, device 305, etc.) receiving a target goal for at least one user at block 205. The target goal can include one or more user targets associated with gameplay. Target goals may be used for controlling duration of gameplay, such as limiting or setting a daily allowance of content presentation for a user. According to embodiments, target goals may set a target amount of training for a user that desires to train for one or more electronic games for one or more time intervals. Target goals may also include one or more in-game performance goals, including one or more of a game task, level completion, object location, and time to complete one or more game tasks. Accordingly, target goals may provide one or more of lifestyle goals and performance goals. User targets may be received by way of a control device interface using one or more of on screen controls, device menus and voice inputs. Users may set target goals using one or more control device interfaces including interfaces configured to receive a time limit for presentation of the electronic game content. At block 206, process 200 may optionally including receiving a user time allowance. A control device may receive a user time allowance from one or more of a parent account, network device and gaming device interface. User time allowances may be provided for training and for game moderation. Target goals may be input by a user (e.g., self-input) to identify at least one of a target goal and time allowance for electronic game content presentation.

At block 210, process 200 includes controlling electronic game content presentation on a display. According to embodiments, gaming content may be output to a display (e.g., display 106). According to embodiments, electronic game content is presented at block 210 including at least one of audio and video content. Processes and configurations described herein allow for monitoring the duration electronic game content is presented. Controlling electronic game content presentation may be based on a fixed time resource for the user, such as a received user time allowance. When the time allowance expires, a control device may stop presentation of electronic game content. Similarly, a control device may disable game output functions based on the time allowance. The fixed time resource allocating a time amount for gameplay per day.

At block 215, process 200 includes detecting one or more user actions and monitoring duration of electronic game presentation. Detection of user attention may include detecting eye tracking to identify user gaze, objects of interest, and user engagement in general. User actions may detected by one or more control devices, such as hand held devices and wearables. User actions may be detected based on eye tracking data captured of a user during presentation of the electronic game content. User actions and duration of gameplay may be determined based on at least one of camera data, eye tracking data, and content interaction data.

According to embodiments, detecting user actions relative to electronic game content presentation includes measuring use of a time allowance for gameplay based on eye tracking detection of a user. By using eye tracking data, a control device may more accurately determine the period of time a user is viewing a display. In addition, eye tracking data may be monitored to determine a level of engagement with electronic game output. For users with a target goal for training, or users that limit presentation of a game to within a time allowance, a game reward may be presented. The game reward may including one or more audio and video outputs. The game reward may also include one or more currency values for in-game use and game system use.

Detecting user actions can include detecting eye tracking data for the user, eye tracking data may be detected or received from one or more peripheral devices or devices integrated with the gaming device. Eye tracking data can include at least one of a focus point, eye movement, eye movement speed, eye movement frequency, blink rate, pupil dilation and eye opening size. Eye tracking data can include parameters related to a user's eyes, and can also include parameters related to time focusing on gaming content, time looking away from gaming content, and even characteristics such as intensity of a user's gaze. For example, one or more of pupil size, eye direction and eyelid opening size may be used to infer an intent gaze or non-interested gaze. According to embodiments, a gaming device can receive eye tracking inferences and/or monitor the eye tracking data for a player to make determinations about the effect that the game is having on the player. Process 200 may include using eye tracking data to correlate a player's time allowance with presented game content.

According to embodiments, detecting eye tracking data can include processing image data of a user, such as video data of a user's eyes, to assess one or more of user state and eye characteristics. By way of example, raw eye tracking data may be processed to determine where a user is looking and other parameters, such as the amount of pupil dilation, eye movement speed, and eye opening level. According to embodiments, machine learning models may use one or more eye movement models and training data sets characterizing, focused and unfocussed attention. Eye tracking models may include parameters to describe typical eye movements during a gaming session based on a game title, game style of play and game environment. In addition to eye tracking data, a model may be applied to user actions and data received based on user movement and biometrics.

At block 220, process 200 includes updating the electronic game content presentation based on the target goal and the presentation time of the electronic game content. Process 200 may include generating a reward for target goal completion at block 225. Updating the electronic game content presentation includes generating a game system currency reward. Updating the electronic game content presentation includes terminating presentation of the electronic game content based on user playtime exceeding a time allowance.

Process 200 may include ending presentation of game content at block 230. Process 200 allows for one or more features to be provided to users. Process 200 may provide moderation control by limiting the duration electronic game content may be presented during a first time interval, such as on a daily basis. It should be appreciated that other time intervals may be used, for example, the time limit may allow for use over multiple days, or set other periods of time that gameplay may or may not be performed (e.g., restricted in mornings, allowed evenings). In addition to moderation control, process 200 may be performed to assist user with one or more addictive game behaviors. In addition to moderation control, process 200 and device configurations here may also allow for establishing and tracking user training goals. Currency rewards generated by process 200 may be output to incentivize user goal completion.

FIG. 3 illustrates a graphical representation of a device configuration according to one or more embodiments. Device 300 provides a configuration for a device configured for electronic game control for game rewards and target goal control. Device 300 and may relate to a gaming console, media device, and/or handheld device. Device 300 may be configured to present and control gaming content. According to embodiments, device 300 includes sensor/eye tracking device 305, controller 310, and memory 315. Device 300 may also include an interface (e.g., network communication module, input/output (I/O) interface) 320. Device 300 may receive input from a user controller 325, which may be a game controller or a wearable device. Device 300 may output gaming content to a display using interface 320.

Controller 310 may relate to a processor or control device configured to execute one or more operations (e.g., executable instructions) stored in memory 315, such as processes electronic game control for game rewards and target goal control. Memory 315 may be non-transitory memory configured to provide data storage and working memory operations for device 300. Memory 315 may be configured to store computer readable instructions for execution by controller 310 for one or more processes described herein. Interface 320 may be a communications module configured to receive and transmit network communication data.

Device 300 may be configured to receive gaming media (e.g., card, cartridge, disk, etc.) and output visual and audio content of the gaming media to a display. For network games, device 300 may receive game data from a network source. Device 300 may be configured to receive input from one or more peripheral devices, such as sensor 305 and user controller 325.

Controller 310 may be configured to control presentation of gaming content, and detect eye tracking data for at least one user. Controller 310 may also be configured to update presentation of the gaming content based on one or more of a target goal and duration of play.

FIG. 4 illustrates a process for setting at least one target goal according to one or more embodiments. Process 400 may be configured to set one or more user target goals. Process 400 may be performed by a device, such as device 300 and/or controller 310 of FIG. 3. Process 400 may be initiated by a device (e.g., control device 105, device 305, etc.) presenting an electronic game user interface at block 405. The user interface may include one or more elements to receive user gals for in-game performance. Similarly, the user interface may include one or more user interface elements to set and/or time duration goals. According to embodiments, in some cases a time allowance, such as a time restriction, may not be modified by players. At block 410, at least one target goal may be detected from the user interface. At block 415, a control device may set the user target based on one or more target goals detected at block 410. The target goal can include one or more user target parameters for duration and in-game performance.

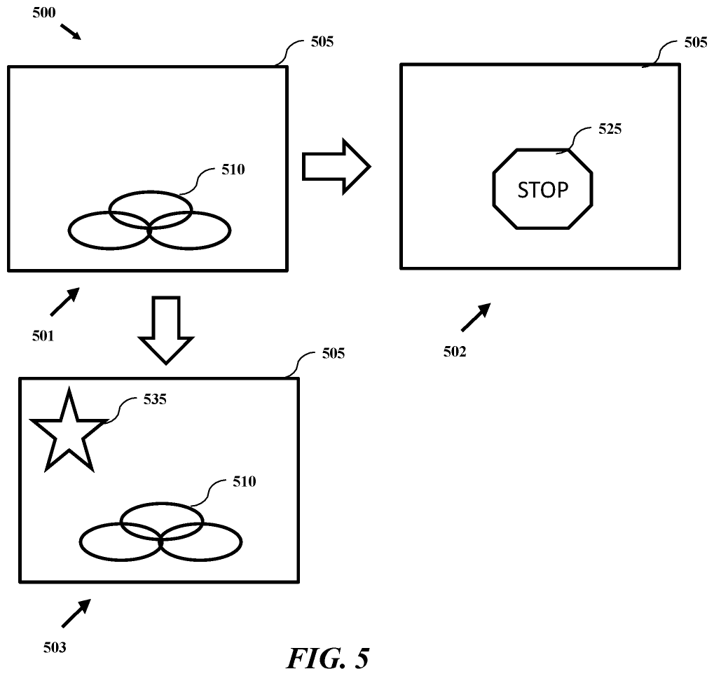

FIG. 5 is a graphical representation of updating electronic game content presentation according to one or more embodiments. According to embodiments, process 500 may be performed by a control device to control electronic game presentation. A control device is configured to presenting electronic game content 501 on display 505. Electronic game content 501 includes one or more game elements 510. According to embodiments, a control device monitors user actions relative to the electronic game presentation including one or more user target goals. Process 500 provides operations to stop presentation of game content when a user time allowance has expired. Process 500 includes updating electronic game content 501 to generate modified electronic game content 502 including a graphical element 525 indicating that a user time allowance has expired. According to embodiments, process 500 may generate one or more rewards when a user target goal is met. Process 500 may include updating electronic game content 501 to generate modified electronic game content 503 including a graphical element 535 indicating that a reward has been generated.

While this disclosure has been particularly shown and described with references to exemplary embodiments thereof, it will be understood by those skilled in the art that various changes in form and details may be made therein without departing from the scope of the claimed embodiments.

What is claimed is:

1. A method for electronic game control for game rewards and target goal control, the method comprising:
receiving, by a device, a target goal for at least one user;
controlling, by a device, electronic game content presentation on a display;
detecting, by the device, user actions relative to the electronic game content presentation, wherein detecting includes monitoring presentation time of the electronic game content and evaluating the user actions relative to the target goal; and
updating, by the device, the electronic game content presentation based on the target goal and the presentation time of the electronic game content, wherein updating includes generating a reward for target goal completion.

2. The method of claim 1, wherein the target goal includes at least one in-game performance goal.

3. The method of claim 1, wherein the target goal includes a time limit for presentation of the electronic game content.

4. The method of claim 1, wherein controlling electronic game content presentation is based on a fixed time resource for the user, the fixed time resource allocating a time amount for gameplay per day.

5. The method of claim 1, wherein detecting user actions relative to electronic game content presentation includes eye tracking detection of a user.

6. The method of claim 1, wherein detecting user actions relative to electronic game content presentation includes measuring use of a time allowance for gameplay based on eye tracking detection of a user, and wherein a game reward includes a time duration parameter for eye track and a currency value for in-game use.

7. The method of claim 1, wherein detecting user actions relative to electronic game content presentation includes detecting a user playtime within a time allowance and wherein updating includes generating a reward for the user.

8. The method of claim 1, wherein updating the electronic game content presentation includes generating a game system currency reward.

9. The method of claim 1, wherein updating the electronic game content presentation includes terminating presentation of the electronic game content based on user playtime exceeding a time allowance.

10. The method of claim 1, further comprising receiving a user goal self input, the user goal self input identifying at least one of a target goal and time allowance for electronic game content presentation.

11. A device configured for electronic game control for game rewards and target goal control, the device comprising:
an interface configured to output gaming content;
a memory storing executable instructions; and
a controller coupled to the interface and the memory, wherein the controller is configured to
receive a target goal for at least one user;
control electronic game content presentation on a display;
detect user actions relative to the electronic game content presentation, wherein detecting includes monitoring presentation time of the electronic game content and evaluating the user actions relative to the target goal; and
update the electronic game content presentation based on the target goal and the presentation time of the electronic game content, wherein updating includes generating a reward for target goal completion.

12. The device of claim 11, wherein the target goal includes at least one in-game performance goal.

13. The device of claim 11, wherein the target goal includes a time limit for presentation of the electronic game content.

14. The device of claim 11, wherein controlling electronic game content presentation is based on a fixed time resource for the user, the fixed time resource allocating a time amount for gameplay per day.

15. The device of claim 11, wherein detecting user actions relative to electronic game content presentation includes eye tracking detection of a user.

16. The device of claim 11, wherein detecting user actions relative to electronic game content presentation includes measuring use of a time allowance for gameplay based on eye tracking detection of a user, and wherein a game reward includes a time duration parameter for eye track and a currency value for in-game use.

17. The device of claim 11, wherein detecting user actions relative to electronic game content presentation includes detecting a user playtime within a time allowance and wherein updating includes generating a reward for the user.

18. The device of claim 11, wherein updating the electronic game content presentation includes generating a game system currency reward.

19. The device of claim 11, wherein updating the electronic game content presentation includes terminating presentation of the electronic game content based on user playtime exceeding a time allowance.

20. The device of claim 11, further comprising receiving a user goal self input, the user goal self input identifying at least one of a target goal and time allowance for electronic game content presentation.
